(19) United States
(12) Patent Application Publication
(10) Pub. No.: US 2024/0110880 A1
(43) Pub. Date: Apr. 4, 2024

(54) Dynamic Data Driven Detector Tuning for Improved Investigation of Samples in Charged Particle Systems

(71) Applicant: FEI Company, Hillsboro, OR (US)

(72) Inventors: Maurice PEEMEN, Rijsbergen (NL); Pavel POTOCEK, Eindhoven (NL); Peter TIEMEIJER, Eindhoven (NL); Remco SCHOENMAKERS, Best (NL); Herman LEMMENS, Hove (BE)

(73) Assignee: FEI Company, Hillsboro, OR (US)

(21) Appl. No.: 17/958,174

(22) Filed: Sep. 30, 2022

(51) Int. Cl. G01N 23/2206; G01N 23/2251

(52) U.S. Cl. CPC G01N 23/2206; G01N 23/2251; G01N 2223/045; G01N 2223/07; G01N 2223/418; G01N 2223/507

(57) ABSTRACT

Methods and systems for using dynamic data-driven detector tuning to investigate a sample with a charged particle microscopy system are disclosed herein. Methods and systems according to the present disclosure include acquiring sample data for a region of interest on the sample, and then determining one or more materials present in the region of interest. Once the materials are identified, a differentiation detector window is identified for the one or more materials, and the detector settings of a detector are adjusted such that the detector obtains information within the differentiation detector window. Thus, as the sample is subsequently scanned, the detector obtains an optimal range of information that is allows for efficient differentiation among the one or more materials.

### BACKGROUND OF THE INVENTION

Charged particle microscope systems have been developed to allow scientists to investigate and gather information on how microscopic systems work. In pursuit of such knowledge, scientists push the limits of what current charged particle microscope systems are able to investigate. One fundamental limitation that charged particle microscopy faces is the difficulty of imaging or otherwise investigating samples composed of materials that are highly reactive or otherwise susceptible to damage from charged particle or electron beams.

This is especially a problem when scientists attempt to measure the chemical context (e.g., oxidation state, ionization, valence state, etc.) of elements using analytical techniques such as EELS, as such techniques require an excessively long dwell time to obtain precise chemical information. Using present techniques, current charged particle systems struggle to obtain high resolution chemical contexts for samples before the cumulative damage caused by irradiation from the system's charged particle or electron beam destroys the material being investigated. This problem is exacerbated for samples composed highly reactive materials, such as batteries, as the beam dose that such reactive materials can receive before being damaged is much lower. Accordingly, there is desired to have new systems and methods for investigating samples that are able to acquire the chemical context of sample materials with reduced beam dosage requirements.

### SUMMARY OF THE INVENTION

Methods for using dynamic data-driven detector tuning to investigate a sample with a charged particle microscopy system according to the present disclosure include acquiring sample data for a region of interest on the sample, and then determining one or more materials present in the region of interest. Once the materials are identified, a differentiation detector window is identified for the one or more materials, and the detector settings of a detector are adjusted such that the detector obtains information within the differentiation detector window. Thus, as the sample is subsequently scanned, the detector obtains an optimal range of information that is allows for efficient differentiation among the one or more materials.

Systems for investigating a sample using dynamic data-driven detector tuning to according to the present disclosure may comprise a sample holder configured to hold a sample, a charged particle source configured to emit a beam of charged particles towards the sample, an optical column configured to cause the beam of charged particles to be incident on the sample, and one or more detectors configured to detect charged particles of the charged particle beam and/or emissions resultant from the charged particle beam being incident on the sample. According to the present disclosure the one or more detectors include an adjustable detector having adjustable detector settings, wherein the detector settings of the adjustable detector can be changed so that the adjustable detector obtains information within a desired differentiation detector window. The systems also include one or more processors, and a memory storing computer readable instructions that, when executed by the one or more processors, cause the corresponding system to perform one or more steps of methods according to the present disclosure.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicates similar or identical items.

FIG. 1 illustrates example environment for data driven detector tuning for investigation of a sample in charged particle systems, according to the present disclosure.

FIG. 2 illustrates a sample process for data driven detector tuning for investigation of a sample in charged particle systems. according to the present invention.

FIGS. 3 and 4 illustrate sets of diagrams that illustrate example processes for determining actual materials present in regions of a sample.

Like reference numerals refer to corresponding parts throughout the several views of the drawings. Generally, in the figures, elements that are likely to be included in a given example are illustrated in solid lines, while elements that are optional to a given example are illustrated in broken lines. However, elements that are illustrated in solid lines are not essential to all examples of the present disclosure, and an element shown in solid lines may be omitted from a particular example without departing from the scope of the present disclosure.

### DETAILED DESCRIPTION OF EMBODIMENTS

Methods and systems for data driven detector tuning for charged particle systems, are included herein. More specifically, the methods and systems disclosed herein include and/or are configured to determine a detector window that allows for efficient (i) differentiation of materials, and/or (ii) chemical context of such materials in sample, and then adjust the settings of a detector in a charged particle system to allow for data to be collected within the determined window. In this way, the methods and system of the present invention are able to use information and/or images of a sample region to determine materials and/or material characteristics that are potentially present within the sample region, and then dynamically determine an optimal differentiation detector window such that the detector can obtain sufficient data to allow for subtle material/material characteristics differentiation with a very low dose beam. According to the present disclosure, the differentiation detector window corresponds to detector settings that result in the corresponding detector capturing sample data of a desired characteristic range (e.g., intensity range, energy resolution, energy range, etc.) that includes a differentiating feature that allows a material or a characteristic of the material present in the sample to be identified out of one or more potential materials or potential characteristics of the materials. For example, a potential material may correspond to any of a type of compound, a chemical, an element, an ionization state, an oxidation state, a plasmon, a plasmon peak, a phonon, a valence state, etc. Because prior systems use less efficient set-ups of detectors, these prior systems required high beam dosages before detectors could obtain sufficient data to make such subtle differentiations, some materials and material characteristics have been difficult or impossible to determine due to the degradation of the sample due to beam irradiation. However, since the differentiation detector window optimally causes the detector system specifically captures a characteristic range of sample data that includes a differentiating feature, the systems and methods of the present disclosure are able identify sample materials with lower beam dosages and/or dwell times.

That is, the present system makes an initial determination on the potential materials/material characteristics of the sample, then uses this determination to identify the differentiations that are necessary to identify materials/material characteristics, and then dynamically determines and sets the detector window to most efficiently capture detector data indicative of the identified differentiations, the methods and systems of the present invention are able to quickly differentiate and identify subtle material/material characteristics. Additionally, the methods and system of the present disclosure may determine a plurality of detector windows that each relate to the most efficient detector settings to obtain data for the differentiation between corresponding material/material characteristics, such that multiple material/material characteristics can be quickly determined within a sample region without damaging the sample.

In various embodiments, the charged particle beam may be scanned one or more times across an entire region with each determined detector window to obtain the desired detector data for the corresponding differentiation. Alternatively, the charged particle beam may only scan particular regions of a sample region that are expected to have a potential material/material characteristic for each corresponding detector window (e.g., changing the detector window to the optimal settings at each pixel or point of the sample, scanning a plurality of pixels/sample points with a same setting before changing the detector window and scanning a new set of pixels/sample points, etc.) to further reduce the time to results and sample damage due to irradiation. Not only does this reduce time to results for operators, but it also allows for new materials/material characteristics to be identified while reducing sample damage. According to the present disclosure, the methods and systems may

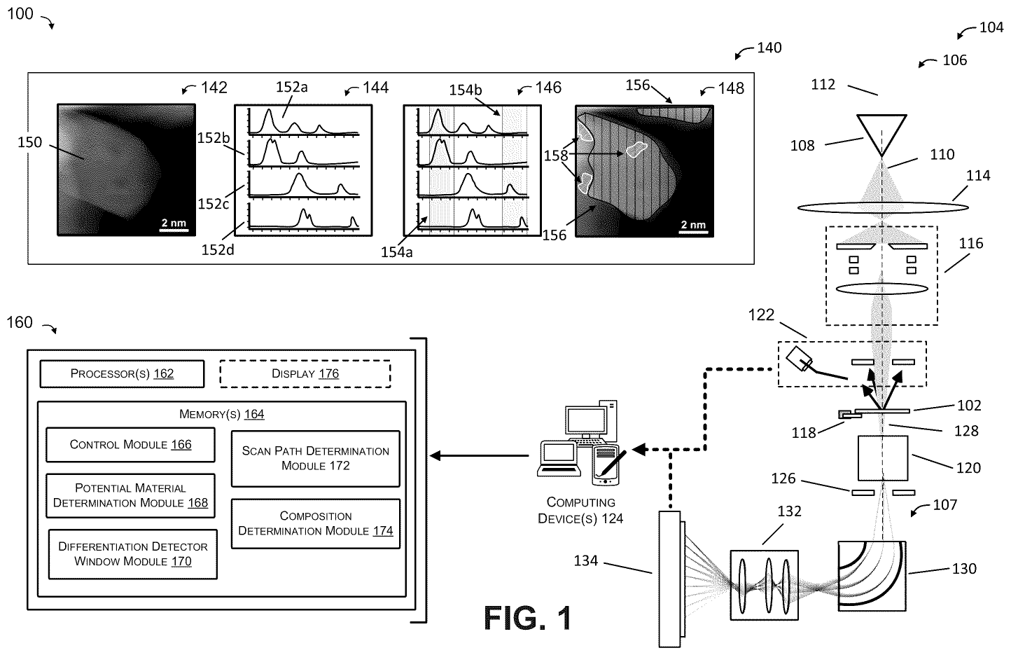

FIG. 1 is an illustration of an example environment 100 for data driven detector tuning for investigation of a sample 102 in charged particle systems, according to the present disclosure. Specifically, FIG. 1 shows example environment 100 as including example charged particle system(s) 104 for investigation and/or analysis of the sample 102. The example charged particle system(s) 104 may be or include one or more different types of optical, and/or charged particle microscopes, such as, but not limited to, a scanning electron microscope (SEM), a scanning transmission electron microscope (STEM), a transmission electron microscope (TEM), a charged particle microscope (CPM), a cryo-compatible microscope, focused ion beam microscope (FIBs), dual beam microscopy system, or combinations thereof. FIG. 1 shows the example charged particle microscope system(s) 104 as being a scanning transmission electron microscope (STEM) 106.

The example charged particle microscope system(s) 104 includes a charged particle source 108 (e.g., a thermal electron source, Schottky-emission source, field emission source, etc.) that emits an electron beam 110 along an emission axis 112 and towards an accelerator lens 114. The emission axis 112 is a central axis that runs along the length of the example charged particle microscope system(s) 104 from the charged particle source 108 and through the sample 102. The accelerator lens 114 that accelerates/decelerates, focuses, and/or directs the electron beam 110 towards a focusing column 116. The focusing column 116 focuses the electron beam 110 so that it is incident on at least a portion of the sample 102. In some embodiments, the focusing column 116 may include one or more of an aperture, scan coils, and upper condenser lens. The focusing column focuses electrons from electron source into a small spot on the sample. Different locations of the sample 102 may be scanned by adjusting the electron beam direction via the scan coils. Additionally, the focusing column 116 may correct and/or tune aberrations (e.g., geometric aberrations, chromatic aberrations) of the electron beam 110. FIG. 1 further illustrates the example charged particle microscope system(s) 104 as further including a sample holder 118 configured to hold the sample 102, and a sample stage that is able to translate, rotate, and/or tilt the sample 102 and sample holder 118 in relation to the example charged particle microscope system(s) 104.

FIG. 1 also shows the example charged particle microscope system(s) 104 as including detector systems 122, 126, and 134. While FIG. 1 illustrates the example charged particle microscope system(s) 104 as including three separate detector systems, a person having skill in the art would understand that an example charged particle microscope system(s) 104 as including may have a single detector system, or additional detector systems of the same or different modalities. Potential modalities in the example charged particle microscope system(s) 104 may include transmission electron microscopy (TEM) dark field imaging, TEM bright field imaging, diffraction pattern imaging, scanning transmission electron microscopy (STEM) bright field imaging, STEM dark field imaging, electron energy loss spectroscopy (EELS), energy dispersive X-ray spectroscopy (EDS, EDX, or XEDS), cathodoluminescence, and backscatter electrons (BSE). For example, a charged particle microscope system may include a high angle annular dark field (HAADF) detector system 126 as a first detector modality and an EDS detector system 122 as a second detector modality. The multiple detector systems 122 are further shown as being connected to one or more computing devices 124.

The STEM system 106 is further illustrated as having a projector lenses/projector system 120 that receive the portions of the charged particle beam 110 that transmit through the sample 102. Electrons 128 scattered by the sample 102 may be recorded by a STEM detectors 126, and/or may enter the EELS spectrometer system 107. The spectrometer system 107 comprises a dispersive element 130 which fans out the electrons to a spectrum, and a system of lenses 132 which magnifies the spectrum to a magnified spectrum at detector 134.

The computing device(s) 124 are configured to control operation of the example charged particle microscope system(s) 104, generate images of sample 102 and/or otherwise determine or interpret data from the detector systems 122, 126, and 134. According to the present invention, the computing device(s) 124 are configured to cause the charged particle microscope system(s) 104 to irradiate one or more locations on a surface region of the sample 102 with charged particle beam 110 (e.g., an electron beam), obtain detector data from a detector system 122, 126, and 134 (e.g., a dark field, EELS, EDS, EDX, XEDS or other type of imaging detector system), and then generate sample information (e.g., spectrum image, energy loss spectrum, a diffraction pattern, an initial image of the surface region, etc.) based on the detector data. The computing device(s) 124 are further configured to identify sample characteristics for regions on the surface within the initial sample information.

According to the present disclosure, the computing device(s) 124 are configured to initially acquire sample data for a region of interest on a surface of the sample 102. The acquired sample data may correspond to an image of the region, an EDX scan of the region, a STEM scan of the region, an EELS scan of the region, a low resolution EELS scan of the region, a low resolution EDX scan of the region, or another type of data from which the computing device 124 can determine potential materials present in the region. A scan may be configured to consist of regular path in which the beam is scanned line by line over the sample, or in a less regular path such as a Hilbert scan or a sparse scan. A scan path may be configured to probe every point on the sample or to probe only a limited sub-region or limited number of (possibly arbitrarily distributed) points on the sample. Furthermore, a scan may be configured as a ‘single scan’ in which every scanned point on the sample (or, equivalently, every pixel in the resulting scan image) is visited once, or as a ‘multiple scan’ in which every point on the sample is visited multiple times. In some embodiments, the computing device(s) 124 may cause the charged particle microscope system(s) 104 to acquire the initial sample data for the region of interest on a surface of the sample 102. Such an initial acquisition of the sample data can be done rapidly and with a low dose of charged particle beam irradiation, as the initial sample data is used by the computing device(s) 124 to identify sample materials that are potentially present in the region of interest. Alternatively, or in addition, the computing device(s) 124 may obtain some of all of the initial sample data from a network, a hardware connection, an accessible memory, and/or user input.

The computing device(s) 124 are then configured to determine one or more materials that are likely to be present in the region of the sample 102 based on acquired the initial sample data. Due to the low dose required to identify materials in the sample using the systems and methods of the present disclosure, the types of materials that can be differentiated and/or identified include material types that have previously been difficult or impossible to be differentiated and/or identified. For example, potential materials that can be identified as being potentially present in the sample (and subsequently being differentiated/identified) include but is not limited to types of compounds, types of chemicals, elements, oxidations states of materials, plasmons, plasmon peaks, valence states of atoms, etc.

In various embodiments, the materials that are potentially present in the region of the sample 102 is determined based on the sample data that has been initially acquired. In some embodiments, the computing device(s) 124 may use the sample data to identify materials that are potentially present in the sample by assigning a score to the likelihood that the initial sample data indicates the presence of the material, and then select a set of one or more potential materials who have the highest score (i.e., the highest three scoring materials), that exceed a threshold value, or a combination thereof. For example, where the initial sample data includes a low-resolution EELS scan of the region, the computing device 124 may identify one or more materials that have a spectral fingerprint that is similar to the spectrum shown information shown in the initial sample data. A spectral fingerprint corresponds to the spectral information that is obtained from an investigation of the corresponding material. In such examples, the computing device 124 may assign a similarity score between a plurality of spectral fingerprints and the spectrum information of the initial sample information, and then determine one or more materials that are potentially present in the region of the sample based on the scores.

Alternatively, or in addition, the computing device(s) 124 may receive a user input and/or access a data structure that identifies potential materials that could be present in the type of sample, groupings of materials that are commonly confused with each other, and/or materials of interest, and then select the one or more potential materials based on the information in the data structure. For example, based on receiving a user input of a type of sample being investigated and a material of interest, the computing device(s) 124 may access a data structure that identifies a grouping of materials that are likely to be found in the sample type and/or are likely to be misidentified as the material of interest. The computing device(s) 124 may then use this information in combination with the initial sample data to determine the one or more materials that are likely to be present in the region of the sample 102.

In various embodiments, the computing device(s) 124 may further use the initial sample information to identify additional regions of the sample where the one or more materials (and/or characteristics) are likely to be present. For example, based on the initial sample data for the additional regions of the sample having similar information (e.g., similar spectrum, image of the surface of the sample 102 showing similar features/structures, etc.) the computing device(s) 102 may determine that the sample materials are also likely to be present in the additional regions. Alternatively, or in addition, the computing device(s) 124 may independently repeat the process of identifying potential materials based on initial sample data for multiple regions of the sample 102. In this way, the computing device(s) 124 can identify a plurality of sets of one or more potential materials, with each set corresponding to one or more regions of the sample 102.

Once one or more materials (and/or characteristics) that are potentially present in the region of interest of the sample 102 are determined, the computing device(s) 124 then determines a differentiation detector window for the one or more materials that is configured to allow for the detector 122, 126, or 134 to capture sample data of a desired characteristic range (e.g., intensity range, energy resolution, energy range, etc.) that includes a differentiating feature that allows a material or a characteristic of the material present in the sample to be identified out of the one or more potential materials or potential characteristics of the materials. For example, a differentiation windows may correspond to an energy range that is quantized by the detector system 122, 126, or 134, a quantized intensity range (e.g., only capturing detector input with a saturation between 500 and 1200 counts), or other detector settings that result in the capture an energy resolution of a desired range.

As is understood by people skilled in the art, most types of charged particle systems 104, 106, 107 have settings that may be adjusted to enable the system to optimally identify or record the materials (or material characteristics) present in the sample, how materials/material characteristics are distributed across the sample, and/or specific details of one or more particular materials (or material characteristics). For example, the EELS spectrometer 107 includes lenses 132 that can be adjusted to image a large range of an EELS spectrum with moderate energy resolution on detector 134 when in a first alignment, and image a small range of an EELS spectrum with high energy resolution image on detector 134 (e.g., the finite number of pixels in detector 134 limits the simultaneously attainable energy range and energy resolution) when the lenses 132 are in a second alignment. A person skilled in the art would understand that first alignment is optimal for recording EELS spectrum overviews which reveal in one exposure which elements are present in the specimen, while the second alignment is optimal for recording the fine details inside a specific EELS (e.g., a peak that reveals chemical information such as oxidation state). While alignment of lenses 132 is one way in which detector settings of the EELS spectrometer 107 can be adjusted, other example ways of adjusting the detector settings includes, but are not limited to, changing the exposure time per spectrum (e.g., relatively short exposure times are sufficient for establishing just the presence of an EELS peak, thus the presence of a specific element, whereas longer exposure time is needed to collect sufficient signal to properly discern the fine details in an EELS peak), the sub-range of the EELS spectrum which is recorded when the spectrometer is set to record at a high energy resolution, etc.

As another example, in diffraction imaging, the range of the diffraction pattern captured by the detector (typically a 2D image sensor) may be adjusted by changing the lenses of the projection system 120. For example, in the so-called 4D-STEM method, a probe of a few nanometer scans over the sample 102, and a 2D diffraction pattern is recorded at each position (thus generating a 4D data set). When the lenses of the projection system 120 are set to relatively low magnification of the diffraction pattern, the resulting 4D-STEM data-set may be optimal for identifying where the various crystal structures possibly present in the sample are located. Alternatively, when the lenses of the magnifying system are set to relatively high magnification of the diffraction pattern, the resulting 4D-STEM data-set may be optimal for quantifying distortions in the lattice structure (due to, for example, stress or dopants). Persons having skill in the art know that other settings of the 4D-STEM experiment set-up that can be adjusted are exposure time per diffraction image, or which sub-area of the diffraction pattern is recorded when the magnifying system is set to record at high magnification of the diffraction pattern.

In the above examples, the settings of the detector may be adjusted such that the detector selects a specific window of a spectrum or image, such that, in this specific window, a sufficient signal and/or resolution is available to enable differentiation between the one or more particular details in material and/or material characteristics desired by an operator. We will call such setting which enables such differentiation the ‘differentiation detector window’ (DDW). As is clear from above examples, and as those skilled in the art know, the process of recording a data set with the corresponding DDW settings is much more time consuming than merely recording a data set with settings that are used to identify which materials are generally present in the sample and/or how they are distributed across the sample. It is therefore advantageous and desirable to limit acquisitions using the DDW settings only to regions where the particular materials/material characteristics to which the DDW is optimal are located (or which are potentially located) on the sample.

It is also noted that the settings which can be adjusted to define the DDW do not necessarily only comprise parameters as magnification and sub-range of spectrum or image, but can also comprise settings other such as detector amplification, detector brightness, and detector bias. Typically, all detector settings that cannot be switched near-instantaneously (i.e., within a time significantly shorter than the time required for one detector read-out) can be part of the set of settings defining the DDW.

In some embodiments, the computing device(s) 124 may use preset differentiation detection windows for differentiating between particular materials. Alternatively, the computing device(s) 124 may compare spectral fingerprints associated with each of the potential materials and identify spectral ranges and/or detector windows that capture at least one difference that allows the materials to be differentiated (e.g., by accessing a library of expected spectra for different materials of interest). For example, where two spectral fingerprints are nearly identical except for particular portion spectral range that includes a peak in the spectral fingerprint for a first potential material a subtle double peak in the spectral fingerprint for a second potential material, the computing device(s) 124 can select a differentiation detector window that corresponds to the particular portion of the spectral range.

In some embodiments, the computing device(s) 124 are configured to adjust the detector settings of a detector 122 to cause the detector to obtain information within the differentiation detector window. In this way, when the detector 122 is configured to acquire sample information within this differentiation detector window, a user and/or algorithm would be able to quickly determine what material is actually present in the region of the sample by determining whether a single peak or a double peak occurs within the sample data. For example, where the detector 122 is an EDX detector, the detector settings may cause the detector to capture sample data that corresponds to X-rays having energies within a range that includes a differentiating feature between one or more potential materials. In another example, where the detector 122 is a pixelated detector, the detector settings may cause the detector to capture sample data with a specific camera length that allows for the visualization of a part of the diffraction space that includes a differentiating feature between one or more potential materials. Because the detector 122 is only capturing sample data within the differentiation detector window, the amount of data needed to identify the material present in the sample is greatly reduced, allowing a lower power charged particle beam to be used to irradiate the sample, a shorter amount of time spent irradiating the sample, or both. In this way, the systems and methods of the present disclosure are able to efficiently and quickly identify the materials present in a sample with much improved time to results and greatly reduced sample damage due to beam dose.

The computing device 124 may then cause the charged particle microscope system(s) 104 to initiate an investigation of the corresponding region of the sample 102. In various embodiments, the computing device 124 may cause the charged particle microscope system(s) 104 to scan a single region of the sample 102, may scan a plurality of regions of the sample 102 that have been determined to have the same materials potentially present, or may scan an entire surface of interest with the detector 122 being configured to obtain sample data within the differentiation detector window.

Additionally, in embodiments where the computing devices 124 have determined multiple differentiation detector windows, the computing devices 124 may cause the settings of the detector 122 to be adjusted to reflect an additional detector window, and then cause the charged particle microscope system(s) 104. In some cases, the new differentiation detector window may have been determined to capture a difference in the spectral fingerprint for two new potential materials in the same and/or a different region of the sample 102. Alternatively, the new differentiation detector window may have been determined to capture a difference in the one or more potential materials associated with a previous differentiation detector window which still remain to be differentiated by a previous scan (e.g., the previous scan had insufficient data to identify an individual material, a subset of potential material still needs to be differentiated, etc.).

The computing devices 124 may cause the charged particle microscope system(s) 104 to scan the sample with the detector 122 being configured to obtain sample data within multiple different differentiation detector windows. For example, the charged particle microscope system(s) 104 may first scan a first plurality of regions of the sample 102 associated with first potential materials used to determine a first differentiation detector window, and then scan a plurality of second regions of the sample 102 associated with second potential materials used to determine a second differentiation detector window. Alternatively, the charged particle microscope system(s) 104 may cause the charged particle beam 110 to scan along the surface of the sample 102 along a known path, and the computing devices 124 may cause the detector settings of the detector 122 to dynamically change to the determined differentiation detector window for the corresponding region of the sample 102 that is currently being/about to be scanned.

Then, because the sample data obtained by the detector 122 is within the differentiation detector window that was selected to capture only sample data that differentiations between potential materials in the sample, the computing device 124 is able to then determine the material that is actually present in a region of the sample 102 based on the sample data obtained from low dose irradiation of the region. For example, according to the present invention, where the differentiation detector window was determined based on potential materials corresponding to a plurality of valance states for a particular atom, the computing device 124 may identify the valence states of individual atoms as they are scanned with a low dose beam.

Those skilled in the art will appreciate that the computing devices 124 depicted in FIG. 1 are merely illustrative and are not intended to limit the scope of the present disclosure. The computing system and devices may include any combination of hardware or software that can perform the indicated functions, including computers, network devices, internet appliances, PDAs, wireless phones, controllers, oscilloscopes, amplifiers, etc. The computing devices 124 may also be connected to other devices that are not illustrated, or instead may operate as a stand-alone system. In addition, the functionality provided by the illustrated components may in some implementations be combined in fewer components or distributed in additional components. Similarly, in some implementations, the functionality of some of the illustrated components may not be provided and/or other additional functionality may be available.

It is also noted that the computing device(s) 124 may be a component of the example charged particle microscope system(s) 124, may be a separate device from the example charged particle microscope system(s) 104 which is in communication with the example charged particle microscope system(s) 104 via a network communication interface, or a combination thereof. For example, an example charged particle microscope system(s) 104 may include a first computing device 124 that is a component portion of the example charged particle microscope system(s) 104, and which acts as a controller that drives the operation of the example charged particle microscope system(s) 104 (e.g., adjust the scanning location on the sample 102 by operating the scan coils, causes translations of the sample 102, etc.). In such an embodiment the example charged particle microscope system(s) 104 may also include a second computing device 124 that is desktop computer separate from the example charged particle microscope system(s) 104, and which is executable to process data received from one or more detector system(s) 122 to generate images of the sample 102, determine scan strategies for the sample 102, and/or perform other types of analysis. The computing devices 124 may further be configured to receive user selections via a keyboard, mouse, touchpad, touchscreen, etc.

FIG. 1 also depicts a visual flow diagram 140 that includes a plurality of images that together depict an example process that may be performed by the computing device(s) 124 for data driven detector tuning for investigation of a sample 102 in charged particle systems, according to the present disclosure. For example, image 142 shows an image 150 of a region of sample 102 that is generated by computing device(s) 124 based on initial sensor data from a detector system 122. Specifically, FIG. 1 illustrates a image of a sample 102 obtained with a HAADF detector data. According to the present invention, the computing device(s) 124 are configured to identify potential materials present in the sample 102 based on the initial sample information. Materials that can be identified as potentially being present in the sample (and subsequently differentiated) according to the present invention includes, without limitation, types of compounds, types of chemicals, elements, oxidation states of materials, plasmons, plasmon peaks, valence stats of atoms, etc. For example, the sample 102 depicted in image 142 is composed of several elements, including Oxygen, Cerium, and Iron.

In various examples, such initial sample information may include an image, an EDX scan, a STEM scan, an EELS scan, a low resolution EELS scan, a low resolution EDX, or another type of data from which a set of potential materials located within the sample can be identified. For example, based on a quick low-resolution EELS scan the computing devices 102 may identify portions of the sample from which similar spectral information was obtained, access a set of spectral fingerprints for different materials, and then select two or more materials having similar spectral fingerprints as potentially being located within the corresponding regions of the sample.

Alternatively, or in addition, the initial sample information may include a user input or sample identifier that provides potential materials, sample types, investigation types, expected sample compositions, etc. For example, based on reception of a sample identifier the computing device(s) 124 may determine a set of materials that are expected to be in the sample 102, then may access an image and/or spectral information from an initial scan of the sample 102 to identify portions of the sample that have characteristics which are similar to certain ones of the expected materials (e.g., image show formations having traits, image shows atom size within range for particular materials, spectral information is similar to the spectral fingerprint, etc.).

Image 144 shows a plurality of spectra fingerprints 152 that have been determined to be similar to the spectral information obtained in the initial sample data. Specifically, spectral fingerprints 152a and 152b correspond to spectral fingerprints for a first potential material and a second potential material that are similar to the spectral information obtained from the locations where the large central structure and the upper rightmost structure as depicted in image 142, and spectral fingerprints 152c and 152d correspond to spectral fingerprints for a third potential material and a fourth potential material that are similar to the spectral information obtained from the locations where deposits where depicted within the sample 102 in image 142. The spectral fingerprints may be identified based on a similarity to an initial sample data (e.g., a similarity score), may be based on a cluster of commonly confused materials, may be user selected, etc.

Image 146 shows an updated version of image 144 in which differentiation detector windows 154 have been determined. Specifically, image 146 shows a first differentiation detector window 154a that captures a differentiating feature between the first spectral fingerprint 152a and the second spectral fingerprint 152b, and a second differentiation detector window 154b that captures a differentiating feature between the third spectral fingerprint 152c and the fourth spectral fingerprint 152d. Image 146 shows that differentiation detector window 154a was selected to include a portion of the spectral fingerprints of the potential materials that was both easily differentiable from the third and fourth spectral fingerprints 152c and 152d (i.e., which have no contribution within the window), while also capturing spectral information that efficiently allows the first and second fingerprints 152a and 152b to be differentiated (i.e., the first spectral fingerprint 152a has a single peak within the window while the second spectral fingerprint 152b has a double peak within the window). In various embodiments the differentiation detector window may be determined based on a comparison between the spectral fingerprints of potential materials to identify the differentiating features, or may be based on a preset list of windows for particular sets of materials.

Image 148 illustrates an updated version of image 142 in which the regions of interest on the sample 102 have been scanned with the detector system 122 having been configured to the determined differentiation detector window 154 such that data was obtained that was able to identify the actual material present at the location from the predetermined set of potential materials. Because this scan is acquiring very specific sample data within a window to efficiently make differentiation decisions, the beam dose required to get sufficient sample data to make a material identification is greatly reduced. This allows the systems and methods of the present disclosure to differentiate and identify materials that were previously difficult or impossible to perform. For example, image 148 shows a first set of regions 156 of the sample that were identified as being a first type of element, a second set of regions 158 of the sample that were identified as being a second type of element.

FIG. 1 further includes a schematic diagram illustrating an example computing architecture 160 of the computing devices 124. Example computing architecture 160 illustrates additional details of hardware and software components that can be used to implement the techniques described in the present disclosure. Persons having skill in the art would understand that the computing architecture 160 may be implemented in a single computing device 124 or may be implemented across multiple computing devices. For example, individual modules and/or data constructs depicted in computing architecture 160 may be executed by and/or stored on different computing devices 124. In this way, different process steps of the inventive method according to the present disclosure may be executed and/or performed by separate computing devices 124.

In the example computing architecture 160, the computing device includes one or more processors 162 and memory 164 communicatively coupled to the one or more processors 162. The example computing architecture 160 can include a control module 166, a potential material determination module 168, a differentiation detector window module 170, a scan strategy determination module 172, and a composition determination module 174 stored in the memory 164.

As used herein, the term “module” is intended to represent example divisions of executable instructions for purposes of discussion, and is not intended to represent any type of requirement or required method, manner or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of modules can be implemented in whole or in part by hardware (e.g., a specialized processing unit, etc.) to execute the described functions. As discussed above in various implementations, the modules described herein in association with the example computing architecture 160 can be executed across multiple computing devices 124.

The control module 166 can be executable by the processors 162 to cause a computing device 122 and/or example charged particle microscope system(s) 104 to take one or more actions. For example, the control module 174 may cause the example charged particle microscope system(s) 104 to scan a surface of the sample 102 by causing the charged particle beam 110. The computing device 112 may then be configured to generate an initial image of the surface of the sample 102 based on detector data from a detector system 122 obtained when the surface of the sample 102 is scanned. In an alternate example, the control module 174 may cause the configuration settings of the detector system 122 to be altered such that they obtain sample information within a differentiation detector window, and/or cause the example charged particle microscope system(s) 104 to scan a surface of the sample 102 according to a scanning strategy determined by the computing devices 124 based on the initial image.

The potential material determination module 168 can be executable by the processors 162 to obtain initial sample data for a region of interest on a surface of the sample 102. The acquired sample data may correspond to an image of the region, an EDX scan of the region, an integrated differential phase contrast (IDPC) scan of the region (a STEM method in which the STEM detector is segmented in at least 4 segments, and the difference in signals between opposite segments is recorded. This difference, when integrated, represents the charge distribution in the sample), an EELS scan of the region, a low resolution EELS scan of the region, a low resolution EDX scan of the region, or another type of data from which the potential material determination module 168 can determine potential materials present in the region. The potential material determination module 168 is further configured to determine one or more materials that are likely to be present in the region of the sample 102 based on the initial sample data. Example potential materials that can be identified as being potentially present in the sample (and subsequently being differentiated/identified) include but is not limited to types of compounds, types of chemicals, elements, ionization states of materials, plasmons, plasmon peaks, valence stats of atoms, etc.

In various embodiments, the materials that are potentially present in the region of the sample 102 is determined based on the sample data that has been initially acquired. In some embodiments, the potential material determination module 168 may use the sample data to identify materials that are potentially present in the sample by assigning a score to the likelihood that the initial sample data indicates the presence of the material, and then select a set of one or more potential materials who have the highest score (i.e., the highest three scoring materials), that exceed a threshold value, or a combination thereof. Alternatively, or in addition, the potential material determination module 168 may receive a user input and/or access a data structure that identifies potential materials that could be present in the type of sample, groupings of materials that are commonly confused with each other, and/or materials of interest, and then select the one or more potential materials based on the information in the data structure.

In various embodiments of the present disclosure, the potential material determination module 168 may identify the potential materials within a region interest using one or more of an identification algorithm, a machine learning module (e.g., an artificial neural network (ANN), convolutional neural network (CNN), Fully Convolution Neural Network (FCN) etc.) trained to identify instances of one or more structures of interest, user selections, and/or a combination thereof. For example, a neural network may be employed to segment the initial image according to whether the corresponding pixels contain a material of interest. Where the potential material determination module 168 segments the initial image into a plurality of different types of regions (i.e., regions likely to have a material of interest, regions having a features indicative of materials, etc.) a user may select individual types of regions that are to be investigated and/or select from a list of materials as potentially being present there. In an alternate example, the potential material determination module 168 may apply an algorithm to such a segmented image that is programmed to select regions to be investigated based on the characteristics/features of the regions (e.g., size, shape, location, proximity to other regions, etc.), and assign potential materials located in the regions based on the characteristics/features.

The differentiation detector window module 170 can be executable by the processors 162 to determine an optimal differentiation detector window for the one or more potential materials identified by the potential material determination module 168. In some embodiments, the differentiation detector window module 170 may use preset windows for differentiating between particular materials. Alternatively, the differentiation detector window module 170 may compare spectral fingerprints associated with each of the potential materials and identify spectral ranges and/or detector windows that capture at least one difference that allows the materials to be differentiated (e.g., by accessing a library of expected spectra for different materials of interest). For example, where four potential materials have been identified for a particular reason, the differentiation detector window module 170 may compare the spectral fingerprints of each potential material to find a common window for which each of the potential materials may be identified or verified as not present based on sample data obtained in from region. In some embodiments, the differentiation detector window module 170 may further be executable to adjust the detector settings of a detector 122 to cause the detector to obtain information within the differentiation detector window.

The scan path determination module 172 can be executable by the processors 162 to identify a scan strategy that is especially customized to the region of the sample 102 being investigated. Specifically, the scan path determination module 172 is executable to identify a beam path that the charged particle beam 110 is going to follow when scanning the sample 102. The beam path may correspond to a preprogrammed beam path that is constant for all samples or may be individual customized to the sample being investigated. For example, the scan path determination module 172 may determine a beam path that first irradiates the regions of the sample determined to have the same potential materials and/or are associated with the same differentiation detector window, and then—after adjusting the detector 122 to have a new differentiation detector window—irradiates a second set of regions of the sample which have been determined to have a new set of potential materials and/or have been associated with the new differentiation detector window. Alternatively, the scan path determination module 172 may assign differential detector windows to corresponding portions of the scan path, such that when the sample is investigated, the detector 122 settings are dynamically adjusted so that it has the appropriate differentiation detector window when the corresponding region of the sample is being scanned.

The composition determination module 174 can be executable by the processors 162 to determine compositional information about the materials present in particular regions of interest based on the sample information obtained by the detector system 122 when said region was scanned with the charged particle beam 110 while configurations of the detector system 122 are such that the detector window corresponds to the differentiation detector window determined for said region. For example, based on the sensor data obtained for a specific region, the composition determination module 174 may analyze the sensor data to see if identifying features for one of the potential materials is present. In this way, the composition determination module 174 is able to determine that a potential material is actually present, eliminate the potential that a material is present, determine if another scan is necessary (i.e., insufficient or erroneous sample data for the region), and/or if the process needs to be repeated (e.g., some but not all of the potential materials have been eliminated, and a new differentiated detector window needs to be determined).

As discussed above, the computing devices 124 include one or more processors 162 configured to execute instructions, applications, or programs stored in a memory(s) 164 accessible to the one or more processors. In some examples, the one or more processors 162 may include hardware processors that include, without limitation, a hardware central processing unit (CPU), a graphics processing unit (GPU), and so on. While in many instances the techniques are described herein as being performed by the one or more processors 162, in some instances the techniques may be implemented by one or more hardware logic components, such as a field programmable gate array (FPGA), a complex programmable logic device (CPLD), an application specific integrated circuit (ASIC), a system-on-chip (SoC), or a combination thereof.

The memories 164 accessible to the one or more processors 162 are examples of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device. In general, computer storage media may include computer executable instructions that, when executed by one or more processing units, cause various functions and/or operations described herein to be performed. In contrast, communication media embodies computer-readable instructions, data structures, program modules, or other data in a modulated data signal, such as a carrier wave, or other transmission mechanism. As defined herein, computer storage media does not include communication media.

Those skilled in the art will also appreciate that items or portions thereof may be transferred between memory 164 and other storage devices for purposes of memory management and data integrity. Alternatively, in other implementations, some or all of the software components may execute in memory on another device and communicate with the computing devices 124. Some or all of the system components or data structures may also be stored (e.g., as instructions or structured data) on anon-transitory, computer accessible medium or a portable article to be read by an appropriate drive, various examples of which are described above. In some implementations, instructions stored on a computer-accessible medium separate from the computing devices 124 may be transmitted to the computing devices 124 via transmission media or signals such as electrical, electromagnetic, or digital signals, conveyed via a communication medium such as a wireless link. Various implementations may further include receiving, sending or storing instructions and/or data implemented in accordance with the foregoing description upon a computer-accessible medium.

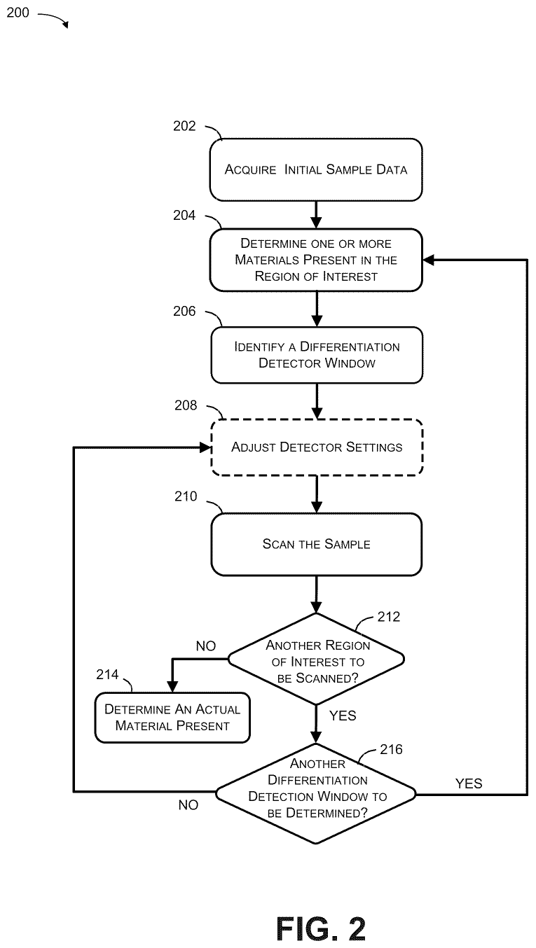

FIG. 2 is a depiction of a sample process 200 for data driven detector tuning for investigation of a sample 102 in charged particle systems according to the present invention. The process 200 may be implemented by any of the environment 100, example charged particle microscope system(s) 104, computing device(s) 124, and computing architecture 160.

At 202, an initial sample data for a sample to be investigated is acquired. The acquired sample data may correspond to an image of the region, an EDX scan of the region, an IDPC scan of the region, an EELS scan of the region, a low resolution EELS scan of the region, a low resolution EDX scan of the region, or another type of data from which the potential material determination module 168 can determine potential materials present in the region. In various embodiments, the initial sample data may be acquired by scanning the sample with a charged particle device (e.g., electron microscope), an imaging device, user input, accessed via an accessible memory, over network connection, or a combination thereof.

At 204, one or more potential materials are determined to potentially be present in a region of interest on the sample based at least in part on the initial sample data. Example potential materials that can be identified as being potentially present in the sample (and subsequently being differentiated/identified) include but is not limited to types of compounds, types of chemicals, elements, ionization states of materials, plasmons, plasmon peaks, valence stats of atoms, etc.

In various embodiments, the potential materials may be determined by an algorithm that is programed and/or trained to identify potential materials in a region of a sample based on initial data associated with said region. For example, the materials that are potentially present in the region of the sample may be determined by assigning a score to the likelihood that the initial sample data indicates the presence of the material, and then selecting a set of one or more potential materials who have the highest score (i.e., the highest three scoring materials), that exceed a threshold value, or a combination thereof. In another example, the potential materials may be determined based on a user input and/or accessible data structure that identifies potential materials that could be present in the type of sample, groupings of materials that are commonly confused with each other, and/or materials of interest, and then select the one or more potential materials based on the information in the data structure.

At 206, a differentiation detector window is identified. The differentiation detector window is a detector window that, when the associated region of the sample is scanned while a detector has the differentiation detector window, the sample data obtained is from a reduced information window that includes a differentiating feature of the one or more potential materials determined in step 204. The differentiation detector window may be a preset windows for differentiating between one or more of the potential materials identified in step 204, or may be determined based on a comparing of the spectral fingerprints associated with each of the potential materials to identify spectral ranges and/or detector windows that capture at least one difference that allows the materials to be differentiated. Then, at 208, the detector settings of the detector are adjusted to obtain new sample data within the differentiation detector window.

At 210, the sample is scanned with a charged particle beam. In some embodiments, scanning the sample comprises scanning the region of interest alone, scanning a large portion of the sample including the region of interest, and/or scanning multiple regions on the sample that have a similar and/or same set of potential materials present.

At 212, it is determined whether an additional region of interest on the sample is to be scanned. If the answer is no, then the process continues to step 214, and the actual materials present in the regions of interest on the sample are determined. Specifically, based on the sample data obtained while each region was scanned while the detector had an associated differentiation detector window, it is determined whether differentiating features are present in the sample data such that one of the potential materials can be either verified as being present or being absent from the associated region of the sample.

If the answer at step 212 is yes, then it is determined at step 216 whether a new differentiation detector window needs to be identified for the additional region of interest on the sample. If the answer at step 216 is yes (i.e., the additional region of the sample has different potential materials or has unknown potential materials), then the process returns to step 204 and one or more new potential materials are determined as potentially being present in the additional region of interest. In this way, an appropriate differentiation detector window can be identified for the additional region of the sample. Alternatively, if it is determined at step 216 that a new differentiation detector window does not need to be determined (i.e., the additional region has the same set of potential materials, the same differentiation detector window, or a different differentiation detector window that has been previously calculated) then the process returns to step 208, where the detector settings are adjusted to the new differentiation detector window (if necessary), and then the process continues to step 210 where the additional region of interest is scanned.

A person having skill in the art would understand that the order of steps shown in FIG. 2 are merely an example order, and that according to the present invention the methods described herein can be carried out in a different order. For example, one initial sample data is obtained, potential materials for a plurality of different regions of the sample and/or associated differentiation detector windows for the plurality of different regions can be determined before the sample is scanned. Additionally, if it is determined at step 214 that there is an insufficient amount of sample data to make a determination of the actual material present in a region, the process of scanning, identifying a differentiation detector window, and/or determining potential materials present may be repeated.

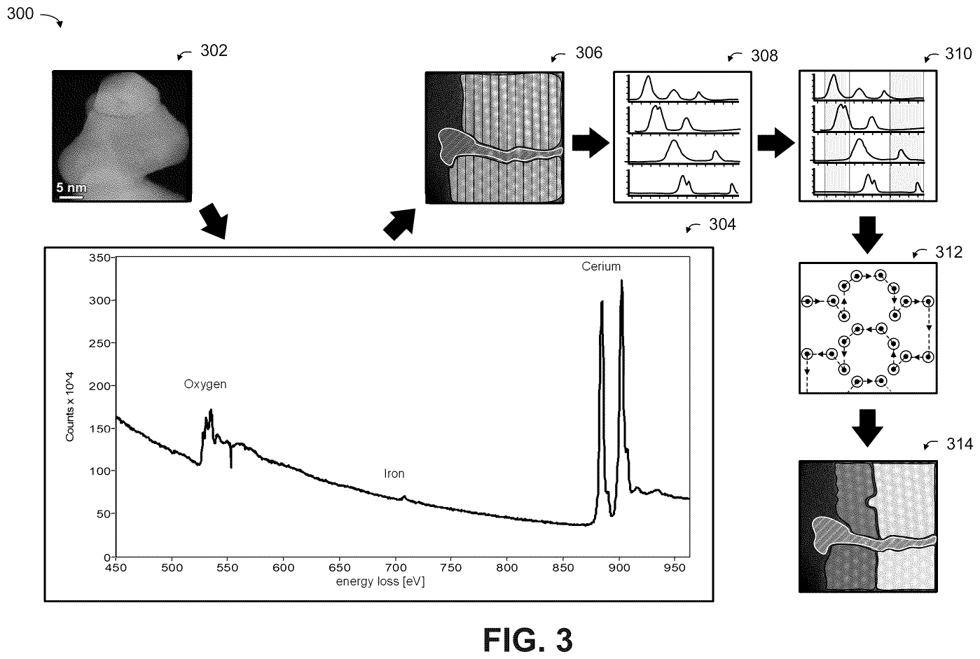

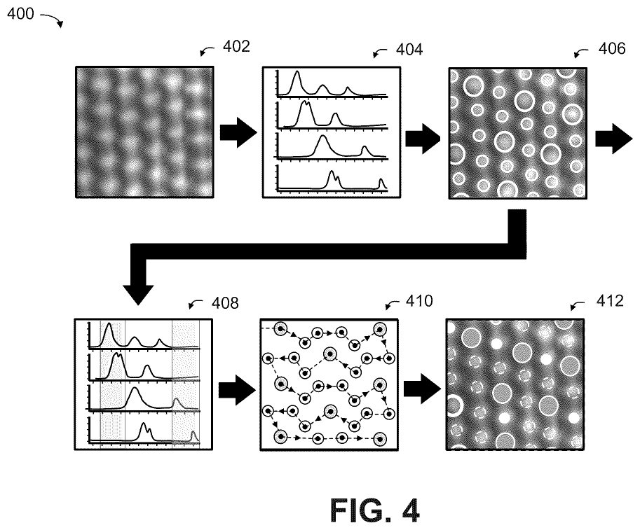

FIGS. 3 and 4 shows a set of diagrams that illustrate example processes for determining actual materials present in regions of a sample. Specifically, FIG. 3 shows a set of diagrams that illustrate a such a process 300 that use multiple scans paths, each with unique differentiation detector windows. FIG. 4 shows a set of diagrams that illustrate such processes 400 which use a single scans path with multiple unique differentiation detector windows.

Initial image 302 corresponds to a low resolution image of a sample comprising Cerium and Iron atoms that was generated using HAADF detector data. Such initial sample data is used to determine potential materials/characteristics of materials located at different regions of the sample. For example, the initial information in images 302 can be used to identify the regions in which atoms are located, an estimated size of the atoms in each region, similarity between the shown atoms in different regions, etc. Additionally, image 304 depicts a low resolution EELS spectrum of the sample shown in 302. In various embodiments, the spectrum in 304 may have been obtained by the same system (e.g., charged particle system 104), sequentially, simultaneously, by different systems. The EELS spectrum shows the presence of Oxygen, Iron, and Cerium in the sample. By combining the information in image 302 and spectrum 304, a mapping of the potential materials at various locations of the sample can be created.

Image 306 shows a sample mask that identifies a first set of regions having vertical stripes within which the low resolution EELS data showed the likely presence of Cerium, and a second region having diagonal stripes which indicates a portion of the sample that the EELS data showed was likely to be composed of Iron. The mask identifies the regions of the sample that are to be irradiated while the detector has the associated differentiation detector window to generate detector data to determine the material present in the location. The regions that are not highlighted in the mask are either not to be irradiated, or are to be briefly irradiated while the beam is moving between regions of interest. Specifically, image 306 shows a zoomed in subsection of the sample depicted in image 302.

FIG. 3 further includes FIG. 308, which illustrates the example spectral fingerprints that could be associated with the potential materials determined to possibly be present in the sample. While the spectral fingerprints shown in 308 are generic spectral fingerprints that have been generated as examples, a person having skill in the art would understand how the spectral fingerprints of the elements would be used according to the present invention. For example, the top two spectral fingerprints of 308 may correspond to two different oxidation states of Cerium, such as Ce³⁺ and Ce⁴⁺, and the two bottom spectral fingerprints may correspond to two different oxidation states of Iron, such as Fe²⁺ and Fe³⁺. However, a person having skill in the art would understand that there may be additional potential materials/spectral fingerprints for each region, and that there may be more than two region types (i.e., more than just a region type associated with a smaller atom (or, equivalently, a lighter atom or an atom that generates less signal in the TEM or STEM image) and a region type associated with a larger atom (or, equivalently, a heavier atom or an atom that generates more signal in the TEM or STEM image).

In 310, the image shows differentiation detector windows that have been identified as allowing both the upper two spectral fingerprints to be easily differentiated from the lower two spectral fingerprints (i.e., the lower two fingerprints have not spectral information associated with their fingerprints), while also allowing the upper two spectral fingerprints to be differentiated from each other (i.e., the first spectral fingerprint has a peak at a lower wavelength than the second spectral fingerprint). By narrowing the detector settings so that it only detects sample data within the differentiation detector window, noise from the remaining portions of the spectrum are not captured, so the sample data acquired is optimally captured to determine the actual material present in the associated location. For example, the leftmost depicted differentiation detector window shows the spectral range within which EELS spectrum data from Ce³⁺ can be differentiated from Ce⁴⁺. Thus, by changing the detector settings to optimally obtain information within this DDW, the detector is able to efficiently capture only the data required to make this differentiation without capturing superfluous information. This allows the determination to be made with reduced beam dose and beam irradiation times.

FIG. 3 also shows an example customized scan strategy 312 for a sample that is generated based on a mask. While the scan strategy shown in 312 is generic, a person having skill in the art would understand how a scan strategy would be derived from the mask 306 and differentiation detector windows 312 according to the present invention. The scan strategy 312 indicates a beam path that the charged particle is to traverse when it irradiates the surface of the sample. Additionally, image 312 shows points in each respective region of interest that the beam is to have a larger dwell time so that detector data for the region of interest can be obtained. Because the detector system is configured to capture only data within the differentiation detector window, the sample data collected for each region may be optimized to quickly identify very minute differentiations in spectra while incurring much reduced sample damage due to shorter required dwell times. This allows the systems and methods of the present disclosure to differentiate between materials in a sample that were previously difficult or impossible to verify. For example, based on the sample data obtained from irradiation of the sample with the scan path shown in 312 and the differentiation detector window shown in 310, each of the regions containing the Iron may be identified as being either in a first oxidation or a second oxidation state. While not shown in FIG. 3, a second scan path may then be determined to identify the scan strategy for investigating the upper and lower regions that were identified as being composed of species of Cerium. These scans may be performed sequentially. For example, the detector settings may be first changed to optimally obtain spectrum information within a first DDW during the first scan, and then before the second scan the detector settings may be changed to second settings so that spectrum data within the second DDW is optimally obtained in the second scan.

Finally, image 314 shows a version of image 306 that has been overlaid with an identification, based on the sample data obtained using the beam path shown in image 312 and the differentiation detector windows shown in 310. As can be seen, the central sliver was determined to be composed entirely of Iron atoms of a single oxidation state, while the upper and lower regions identified in mask 306 have been determined to be composed of a Ce of a first oxidation state near the left edge and Ce of a second oxidation state on the right inward side of the sample.

In FIG. 4, image 402 shows an image a region of a sample comprising an array multiple species of atoms that was generated using HAADF detector data. Such initial sample data is used to determine potential materials located at different regions of the sample. For example, the initial information in image 402 can be used to identify the regions in which an atom is located, an estimated size of the atoms in each region, similarity between the shown atoms in different regions, etc. This can be combined with a low-resolution EELS scan of the sample area to identify the energy loss spectrum for each region containing an atom. By accessing a data structure containing spectral fingerprints for various potential materials (e.g., types of compounds, chemicals, elements, ionization states, oxidation states, plasmon, plasmon peaks, valence states, and/or combinations thereof) two or more potential materials present in each associated region are identified (e.g., by identifying the most similar fingerprints, fingerprints that are commonly confused with each other, predetermined clusters of fingerprints, etc.). For example, it may be determined that the smaller atoms depicted in image 402 correspond to a different element, but the oxidation state of the individual atoms cannot be determined, while the larger atoms shown in the image correspond to one of two different elements. As discussed above, other input may be used in the determination of the potential materials (e.g., user input, sample identifier, sample type, investigation type, other initial types of sample data, etc.).

FIG. 4 further illustrate the spectral fingerprints associated with the potential materials determined to possibly be present in the sample. Image 404 shows four spectral fingerprints, with the upper two spectral fingerprints corresponding to the sample regions including the atom with a smaller diameter, and the two bottom spectral fingerprints corresponding to the regions including the larger diameter atom. However, a person having skill in the art would understand that there may be additional potential materials/spectral fingerprints for each region, and that there may be more than two region types (i.e., more than just a region type associated with a smaller atom and a region type associated with a larger atom).

In FIG. 4, image shows a combined mask 406 that identifies each of the regions associated with the atoms that are to be irradiated with a charged particle beam. Combined mask 406 illustrates a first subset of regions associated with the atoms of the small diameter corresponding to circles of the smaller diameter, and a second subset of regions associated with the atoms of the larger diameter corresponding to circles of the larger diameter. Image 408 shows the spectral fingerprints of the potential materials from image 404 with an overlay of a first differentiation detector window configured to allow accurate and efficient differentiation between the top two spectral fingerprints associated with the first subset of regions, and a second differentiation detector window configured to allow accurate and efficient differentiation between the bottom two spectral fingerprints associated with the second subset of regions

Image 410 shows a customized scan strategy for the sample that is generated based on the combined mask 406. The scan strategy 410 indicates a beam path that the charged particle is to traverse when it irradiates the surface of the sample. While the scan strategy shown in 410 is generic, a person having skill in the art would understand how a scan strategy would be derived from the mask 406 and differentiation detector windows 410 according to the present invention. Image 410 also shows points in each respective region of interest that the beam is to have a larger dwell time so that detector data for the region of interest can be obtained. Additionally, unlike the scan paths shown in FIG. 3, the customized scan strategy 410 includes regions associated with different differentiation detector windows. For example, image 410 illustrates that as the beam travels to regions associated with an atom of a larger diameter the detector settings are adjusted to the second differentiation detector window (shown as a grey circle), and when the beam travels to regions associated with an atom of a smaller diameter the detector settings are adjusted to the first differentiation detector window (shown as a white circle). By dynamically changing the window settings of the detector, the system is able to acquire tailored information for making accurate material determinations for regions having disparate characteristics in a single scan path. Finally, image 412 shows the image 402 where the actual materials present in each region have been identified according to the present disclosure. Specifically, image 412 shows an overlaid version of the image of 402 where, based on the sample data obtained from irradiation of the sample with the scan path shown in 410 and the first differentiation detector window and second differentiation window shown in 408, each of the regions containing the smaller diameter atom have been identified as being an element with first ionization state (i.e., solid dots) or the same element with a different ionization state (i.e., the dashed ring), and the majority of the regions containing the larger diameter atom having been associated with an element of a first type (i.e., the grey circle) with a single region having been determined to include an atom of a second type (i.e., the solid white ring). It is noted that the crystal structure shown in image 412 is merely illustrative of how the systems and methods of the present disclosure operate, and do not reflect actual experimental data or a stable structure.

Examples of inventive subject matter according to the present disclosure are described in the following enumerated paragraphs.
A1. A method for investigation of a sample with a charged particle system using dynamic data-driven detector tuning, the method comprising the steps of: acquiring sample data for a region of interest on the sample; determining one or more materials present in the region of interest; identify a differentiation detector window for the one or more materials; adjusting detector settings of a detector to cause the detector to obtain information within the differentiation detector window; and scanning the sample while the detector has the adjusted detector settings to obtain information within the differentiation detector window.
A2. The method of paragraph A1, wherein the one or more materials present in the region of interest comprise a first material and a second material.
A3. The method of any of paragraphs A1-A2, further comprising: identifying a first material of the one or more materials located at a first location within the region of interest; and identifying a second material of the one or more materials located at a second location within the region of interest.
A3.1. The method of paragraph A3, wherein the first and second material are identified based on the information within the differentiation detector window obtained by the detector having the adjusted detector settings.
A4. The method of any of paragraphs A1-A3.1, wherein the differentiation detector window is determined based on a first spectral fingerprint associated with the first material and a second spectral fingerprint associated with the second material.
A4.1. The method of paragraph A4, wherein the differentiation detector window is determined based on differentiating features in associated spectral fingerprints of the one or more materials present in the region of interest.
A4.2. The method of any of paragraphs A4-A4.1, further comprising: determining a differentiating feature between the first spectral fingerprint and the second spectral fingerprint; and determining the differentiation detector window to include the differentiating feature.
A4.3. The method of any of paragraphs A4-A4.1, wherein determining the differentiation detector window comprises accessing a library of expected spectra for different materials of interest.
A5. The method of any of paragraphs A1-A4.3, further including determining one or more additional materials present in the region of interest.
A5.1. The method of paragraph A5, wherein the one or more additional materials present in the region of interest comprise a third material and a fourth material.
A5.2. The method of any of paragraphs A5-A5.1, wherein the differentiation detector window is further determined based on the associated spectral fingerprints of the one or more additional materials.
A5.2.1. The method of paragraph A5.2, wherein the differentiation detector window is determined so that the differentiation detector window includes a reduced amount of expected spectral data from the associated spectral fingerprints of the one or more additional materials.
A5.2.2. The method of paragraph A5.2, wherein the differentiation detector window is determined so that the differentiation detector window includes a reduced amount of expected spectral data from the associated spectral fingerprints of the one or more additional materials.
A5.3. The method of any of paragraphs A5-A5.1, further comprising determining an additional differentiation detector window based on the associated spectral fingerprints of the one or more additional materials.
A5.3.1. The method of paragraph A5.3, further comprising: determining an additional differentiating feature between a third spectral fingerprint associated with the third material and a fourth spectral fingerprint associated with the fourth material; and determining the additional differentiation detector window to include the additional differentiating feature.
A5.3.2. The method of any of paragraphs A5.3-A5.3.1, wherein the additional differentiation window does not overlap with the differentiation window.
A5.3.3. The method of any of paragraphs A5.3-A5.3.2, wherein the additional differentiation detector window is determined so that the differentiation detector window includes a reduced amount of expected spectral data from the associated spectral fingerprints of the one or more materials.
A5.3.4. The method of any of paragraphs A5.3-A5.3.3, further comprising: adjusting the detector settings of the detector to cause the detector to obtain information within the additional differentiation detector window; and scanning the sample while the detector has the adjusted detector settings to obtain information within the additional differentiation detector window.
A5.3.4.1. The method of paragraph A5.3.4, further comprising identifying the third material as being located at a third location within the region of interest.
A5.3.4.2. The method of any of paragraphs A5.3.4-A5.3.4.1, further comprising identifying the fourth material as being located at a fourth location within the region of interest.
A5.3.4.3. The method of any of paragraphs A5.3.4.1-A5.3.4.2, wherein the first and second material are identified based on the information within the differentiation detector window obtained by the detector having the adjusted detector settings.
A5.4. The method of any of paragraphs A5-A5.3.4.3, further comprising identifying two or more additional differentiation windows.
A5.4.1. The method of paragraph A5.4, wherein scanning corresponds to: scanning one or more first regions associated with the one or more materials with the detector having the adjusted detector settings to obtain information within the differentiation detector window; and scanning one or more second regions associated with the one or more additional materials with the detector having the adjusted detector settings to obtain information within the additional differentiation detector window.
A5.4.1.1. The method of paragraph A5.4.1, wherein the first regions are scanned before the second regions are scanned.
A5.4.1.2. The method of paragraph A5.4.1, wherein scanning the region of interest comprises alternating the detector settings based on the portion of the region of interest being irradiated.
A6. The method of any of paragraphs A1-A5.4.1.2, wherein the targeted detector window has an energy width of less than 500 eV, 400 eV, 250 eV, 100 eV, or 50 eV.
A7. The method of any of paragraphs A1-A6, wherein scanning the sample while the detector has the adjusted detector settings to obtain information within the differentiation detector window comprises scanning a point in the region of interest that is expected to have the one or more materials.
A7.1. The method of paragraph A7, wherein scanning the sample while the detector has the adjusted detector settings comprises scanning a plurality of points in the region of interest that are expected to have the one or more materials.
A8. The method of any of paragraphs A1-A7.1, wherein determining the one or more materials present in the region of interest corresponds to determining one or more potential materials that might be present in the region of interest.
A8.1. The method of paragraph A8, wherein the one or more materials are determined based at least in part on a user input.
A8.1.1. The method of paragraph A8.1, wherein the user input corresponds to a type of sample, a type of investigation, a set of materials of interest, and/or one or more identified materials.
A8.2. The method of any of paragraphs A8-A8.1.1, wherein the one or more materials are determined based at least in part on an initial scan of the region of interest.
A8.2.1. The method of paragraph A8.2, wherein the initial scan is acquired via one of: an EDX scan; an IDPC scan; an EELS scan; a low resolution EELS scan; and a low resolution EDX scan.
A8.2.2. The method of any of paragraphs A8.2-A8.2.1, wherein the initial scan is acquired via a separate device.
A8.3. The method of any of paragraphs A8-A8.2.2, wherein determining one or more materials present in the region of interest comprises determining potential materials associated with a point in the region of interest.
A8.3.1. The method of paragraph A8.3, wherein scanning the sample while the detector has the adjusted detector settings to obtain information within the differentiation detector window comprises: scanning the point; and determining, based on the detected data within the window, whether one of the one or more materials is present at the point.
A8.3.2. The method of any of paragraphs A8.3-A8.3.1, wherein scanning the sample while the detector has the adjusted detector settings to obtain information within the differentiation detector window comprises: scanning the point; and determining, based on the detected data within the window, a material of the one or more materials that is present at the point.
A8.4. The method of any of paragraphs A8-A8.3.2, wherein determining one or more materials present in the region of interest comprises determining potential materials associated with a plurality of first points in the region of interest.
A8.4.1. The method of paragraph A8.4, wherein scanning the sample while the detector has the adjusted detector settings to obtain information within the differentiation detector window comprises: scanning each point of the plurality of first points; and determining, for each of the plurality of first points and based on the detected data within the window associated with the corresponding first point, whether one of the one or more materials is present at the corresponding first point.
A8.4.2. The method of any of paragraphs A8.4-A8.4.1, wherein scanning the sample while the detector has the adjusted detector settings to obtain information within the differentiation detector window comprises: scanning each point of the plurality of first points; and determining, for each of the plurality of first points and based on the detected data within the window associated with the corresponding first point, a material of the one or more materials that is present at the corresponding first point.
A9. The method of any of paragraphs A1-A8.4.1, wherein individual materials of the one or more materials corresponds to: a type of compound; a chemical; an element; an ionization state; a plasmon; a plasmon peak; and a valence state.
B1. A charged particle system for investigating a sample, the system comprising: a sample holder configured to hold a sample; a charged particle source configured to emit a beam of charged particles towards the sample; an optical column configured to cause the beam of charged particles to be incident on the sample; one or more detectors configured to detect charged particles of the charged particle beam and/or emissions resultant from the charged particle beam being incident on the sample, the one or more detectors comprising at least an adjustable detector having adjustable detector settings, wherein the detector settings of the adjustable detector can be changed so that the adjustable detector obtains information within a desired differentiation detector window; one or more processors; and a memory storing computer readable instructions that, when executed by the one or more processors, cause the system to perform the method of any of paragraphs A1-A9.
B2. The charged particle system of paragraph B1, wherein the adjustable detector is able to change the differentiation detector window within 100 ms.
B3. The charged particle system of paragraph B1, wherein the adjustable detector is able to change the differentiation detector window within 10 ms.
C1. Non-transitory computer readable instructions, that when executed on one or more processors of a charged particle microscopy system, cause the one or more processors to perform the methods of any of paragraphs A1-A9.
D1. Use of a charged particle system of any of paragraphs B1-B2.2 to perform any of the methods of paragraphs A1-A9.
E1. Use of the non-transitory computer readable instructions of paragraph C12.
E1.1. Use of the non-transitory computer readable instructions of paragraph C12 to perform any of the methods of paragraphs A1-A9.

What is claimed is:

1. A method for investigation of a sample with a charged particle system using dynamic data-driven detector tuning, the method comprising the steps of:
acquiring initial sample data for a region of interest on the sample;
determining two or more potential materials or material characteristics that are potentially present in the region of interest;
identifying a differentiation detector window for the one or more potential materials or material characteristics;
adjusting detector settings of a detector in the charged particle system such that the detector is configured to obtain information within the differentiation detector window; and
scanning the sample while the detector has the adjusted detector settings to obtain sample information within the differentiation detector window.

2. The method of claim 1, wherein the one or more potential materials or material characteristics present in the region of interest comprise a first material and a second material, and the method further comprises:
identifying, based on the sample information within the differentiation detector window, the first material of the one or more materials as being located at a first location within the region of interest.

3. The method of claim 2, further comprising identifying, based on the sample information within the differentiation, a second material of the one or more materials as being located at a second location within the region of interest.

4. The method of claim 2, wherein the differentiation detector window is determined based on a first spectral fingerprint associated with the first material and a second spectral fingerprint associated with the second material.

5. The method of claim 4, wherein the differentiation detector window is determined based on one or more differentiating features between the first spectral fingerprint associated with the first material and the second spectral fingerprint associated with the second material.

6. The method of claim 4, wherein determining the differentiation detector window comprises:
determining a differentiating feature between the first spectral fingerprint and the second spectral fingerprint; and
determining the differentiation detector window to include the differentiating feature.

7. The method of claim 1, wherein the one or more potential materials or material characteristics present in the region of interest comprise a first material characteristic and a second material characteristic, and the method further comprises:
identifying, based on the sample information within the differentiation detector window, the first material characteristic of the one or more materials as being located at a first location within the region of interest.

8. The method of claim 1, further comprising the steps of:
determining one or more additional materials that are potentially present in the region of interest, wherein the one or more additional materials present in the region of interest comprise a third material and a fourth material; and
wherein the differentiation detector window is further determined based on associated spectral fingerprints of the one or more additional materials.

9. The method of claim 8, wherein the differentiation detector window is determined so that the differentiation detector window includes a reduced amount of expected spectral data from the associated spectral fingerprints of the one or more additional materials.

10. The method of claim 1, further comprising the steps of:
determining one or more additional materials that are potentially present in the region of interest, wherein the one or more additional materials present in the region of interest comprise a third material; and
wherein the differentiation detector window is further determined based on associated spectral fingerprints of the one or more additional materials.

11. The method of claim 1, wherein the differentiation detector window is a first differentiation detector window, and the method further comprising the steps of:
determining one or more additional materials that are potentially present in the region of interest, wherein the one or more additional materials present in the region of interest comprise a third material and a fourth material; and
determining a second differentiation detector window based on associated spectral fingerprints of the one or more additional materials, wherein the second differentiation detector window does not overlap with the first differentiation detector window.

12. The method of claim 11, further comprising the steps of:
adjusting the detector settings of the detector to cause the detector to obtain information within the second differentiation detector window;
scanning the sample while the detector has the adjusted detector settings to obtain additional sample information within the second differentiation detector window; and
identifying, based on the additional sample information within the second differentiation detector window, the third material as being located at a third location within the region of interest.

13. The method of claim 1, wherein the differentiation detector window is a first differentiation detector window, and wherein scanning corresponds to:
scanning one or more first regions associated with the one or more materials with the detector having the adjusted detector settings to obtain information within the first differentiation detector window; and
scanning one or more second regions associated with the one or more additional materials with the detector having the adjusted detector settings to obtain information within a second differentiation detector window that does not overlap with the first differentiation detector window.

14. The method of claim 13, wherein the first regions are scanned before the second regions are scanned.

15. The method of claim 13, wherein scanning the region of interest comprises alternating the detector settings based on the portion of the region of interest being irradiated.

16. The method of claim 1, wherein the determining two or more potential materials or material characteristics that are potentially present in the region of interest is based on the initial sample data for the region of interest on the sample.

17. The method of claim 1, wherein the initial sample data is acquired via one of:
a STEM scan;
an EDX scan;
an IDPC scan;
an EELS scan;
a low resolution EELS scan; and
a low resolution EDX scan.

18. The method of claim 1, wherein individual materials of the one or more potential materials corresponds to:
a type of compound;
a chemical
an element;
an ionization state;
an oxidation state;
a plasmon;
a plasmon peak;
a phonon; and
a valence state.

19. A charged particle system for investigating a sample, the system comprising:
a sample holder configured to hold a sample;
a charged particle source configured to emit a beam of charged particles towards the sample;
an optical column configured to cause the beam of charged particles to be incident on the sample;
one or more detectors configured to detect charged particles of the charged particle beam and/or emissions resultant from the charged particle beam being incident on the sample, the one or more detectors comprising at least an adjustable detector having adjustable detector settings, wherein the detector settings of the adjustable detector can be changed so that the adjustable detector obtains information within a desired differentiation detector window;
one or more processors; and
a memory storing computer readable instructions that, when executed by the one or more processors, cause the system to perform the method of:
acquiring initial sample data for a region of interest on the sample;
determining two or more potential materials that are potentially present in the region of interest;
identifying a differentiation detector window for the one or more potential materials;
adjusting detector settings of a detector in the charged particle system such that the detector is configured to obtain information within the differentiation detector window; and
scanning the sample while the detector has the adjusted detector settings to obtain sample information within the differentiation detector window.

20. The charged particle system of claim 19, wherein the adjustable detector is able to change the differentiation detector window within 10 ms.
